(19) United States
(12) Patent Application Publication
(10) Pub. No.: US 2005/0146415 A1
(43) Pub. Date: Jul. 7, 2005

(54) Electronic apparatus control device

(75) Inventor: Hiromitsu Io, Takefu-shi (JP)

Correspondence Address: REED SMITH LLP;Suite 1400, 3110 Fairview Park Drive, Falls Church, VA, 22042, US

(73) Assignee: Orion Electric Company Ltd.

(21) Appl. No.: 11/013,410

(22) Filed: Dec. 17, 2004

(30) Foreign Application Priority Data
Jan. 6, 2004 (JP) 2004-001031

(51) Int. Cl. G08C 19/00

(52) U.S. Cl. 340/3.71; 340/825.25; 348/734; 386/35

(57) ABSTRACT

The present invention is intended to enable any operation desired by a user to be executed by operating one of combination keys once if the combination keys are provided on a remote controller. A main controller that receives an operation signal from the remote controller causes a key code discrimination section to discriminate a key code included in the operation signal when receiving the operation signal by operating one of the combination keys. The main controller allows a communication processing section to transmit a status command corresponding to the key code to a sub controller. The sub controller determines whether the received status command is valid or invalid based on a present operation state, and transmits a determination result to the main controller. When the status command is valid, an operation according to the operation signal is performed in an operation mode executed by the sub controller. When the status command is invalid, an operation according to the operation signal is performed in an operation mode executed by the main controller.

### BACKGROUND OF THE INVENTION

1. Field of the Invention

The present invention relates to an electronic apparatus control device for operating a multifunctional device that is a combination of a plurality of electronic apparatuses using an operating device.

2. Description of the Related Art

A remote controller is employed when operating a multifunctional device that is a combination of a plurality of electronic apparatuses such as a combination of a plurality of recording and reproducing apparatuses or a combination of a recording and reproducing apparatus and a television receiver. A plurality of operation keys are provided on the remote controller. These operation keys include combination keys for actuating different electronic apparatuses.

When one of the combination keys is operated, it is necessary to determine for which of the electronic apparatuses the combination key is operated. Japanese Utility Model Registration No. 3090086, for example, discloses a remote control device on which a selection key for selecting one of two electronic apparatuses is provided. By operating the selection key, one electronic apparatus is selected and an operation target of a combination key is switched.

With this conventional remote control device, however, a user is required to operate the combination key after operating the selection key, thereby disadvantageously casting a burden on the user. In addition, if the user forgets to operate the selection key and operates only the combination key, a desired operation cannot be performed. If so, the user may possibly misunderstand that some failure occurs to the remote control device although the remote control device is normal.

### SUMMARY OF THE INVENTION

It is an object of the present invention to provide an electronic apparatus control device that enables appropriately performing an operation by operating one combination key without casting a burden on a user.

According to the present invention, there is provided an electronic apparatus control device comprising: a plurality of controllers that execute different operation modes, respectively; and an operating device that inputs an operation signal for executing one of the operation modes. The operating device includes a plurality of combination keys corresponding to operations performed in the plurality of operation modes, respectively. The respective controllers are communicable with one another. A main controller among the controllers includes: receiving means for receiving the operation signal from the operating device; and inquiry means for transmitting an inquiry to the controllers other than the main controller to confirm whether the operation signal is valid or invalid when the main controller receives the operation signal by operating one of the combination keys. Each of the other controllers includes response means for responding to the inquiry from the main controller.

Namely, the operation signal is an instruction to an operation mode that is now being executed. Therefore, if it is recognized that which of the controllers is executing the present operation mode, an operation according to the operation signal can be performed. The main controller, therefore, confirms whether the operation signal by operating one of the combination keys is valid or invalid in the operation mode that is now being executed. To do so, the main controller selects a status command corresponding to the operation signal, and transmits the selected status command to the other controllers.

Each of the other controllers determines whether the status command is valid or invalid based on the present operation state, and transmits a determination result to the main controller. If the status command is valid, the operation according to the operation signal can be performed. If the status command is invalid, the operation according to the operation signal cannot be performed. The main controller can thereby recognize the present operation mode, and exercises a control according to the recognition.

Namely, when one of the other controllers determines that the status command is valid, this controller is executing the operation mode. Therefore, this controller performs the operation according to the operation signal in the current operation mode. When receiving the operation signal related to this operation mode, the main controller cooperates with the other controller to execute an operation. If one of the other controllers determines that the status command is invalid, the main controller performs an operation according to the operation signal in the operation mode executed by the main controller.

According to the present invention, when one of the combination keys is operated, the present operation mode is discriminated, whereby it is possible to ensure executing a correct operation according to the combination keys. It is, therefore, unnecessary to separately provide a selection key for selecting one of the operation modes. The number of keys does not increase and there is no need to perform a key operation a plurality of times, thereby making it possible to simplify the operation.

### BRIEF DESCRIPTION OF THE DRAWINGS

FIG. 1 is a schematic block diagram of a multifunctional device that is a combination of a television receiver and a recording and reproducing apparatus according to the present invention; and

FIG. 2 is a flowchart that depicts operations performed by an electronic apparatus control device when a combination key is operated.

### DESCRIPTION OF THE PREFERRED EMBODIMENT

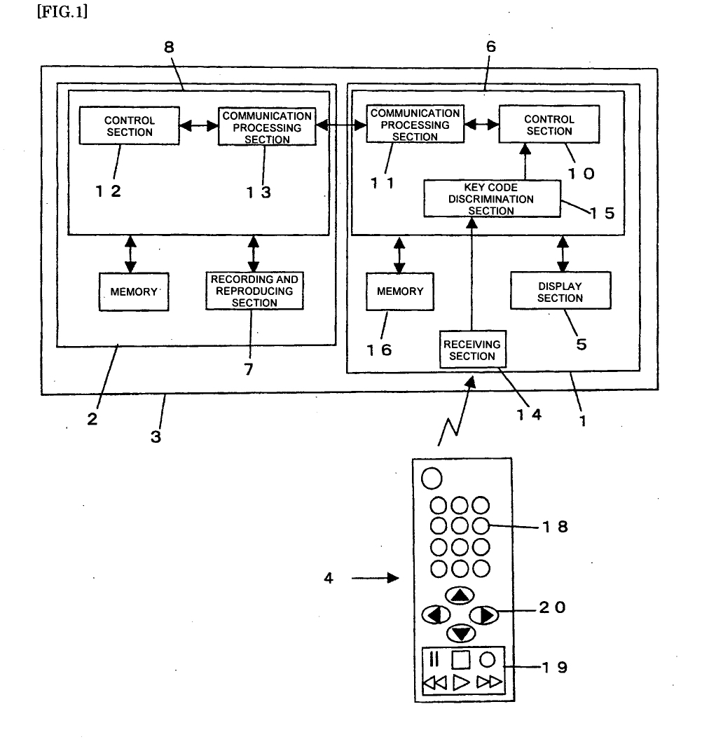

FIG. 1 depicts a multifunctional device that is a combination of a plurality of electronic apparatuses according to one embodiment of the present invention. In this embodiment shown in FIG. 1, the electronic apparatuses are a television receiver 1 and a recording and reproducing apparatus 2. The television receiver 1 and the recording and reproducing apparatus 2 are incorporated into one housing 3 and operated by a remote controller 4.

The television receiver 1 includes a display section 5 composed by a cathode-ray tube (CRT), a video processing circuit, and the like, and a main controller 6 that controls the display section 5. The recording and reproducing apparatus 2 includes a recording and reproducing section 7 that records and reproduces video and voice signals on and from a digital recording medium such as a digital versatile disk (DVD) or a hard disk, and a sub controller 8 that controls the recording and reproducing section 7. The television receiver 1 serves as an output apparatus for the recording and reproducing apparatus 2. Since a structure of each of the television receiver 1 and the recording and reproducing apparatus 2 is well known, it will not be described herein in detail.

The main controller 6 is composed by a microcomputer, and includes a control section 10 and a communication processing section 11. Likewise, the sub controller 8 is composed by a microcomputer, and includes a control section 12 and a communication processing section 13. The main controller 6 and the sub controller 8 are connected to each other by a communication line. Each of the communication processing sections 11 and 13 of the main controller 6 and the sub controller 8 holds a communication using an I2C bus or a universal asynchronous receiver transmitter (“UART”). The television receiver 1 also includes a receiving section 14 that receives an operation signal from the remote controller 4. The receiving section 14 is connected to a key code discrimination section 15 included in the main controller 6. The operation signal from the remote controller 4 includes a key code corresponding to one operation key. The key code discrimination section 15 discriminates a content of the key code included in the received operation signal while referring to a code table stored in a programmable memory 16. The code table may be stored in a read only memory (ROM) included in the microcomputer.

The sub controller 8 executes a recording and reproducing mode for recording and reproducing a signal to and from a recording medium. The main controller 6 executes a television mode for displaying a television broadcast. Further, the main controller 6 controls an operation performed by the sub controller 8 according to the operation signal from the remote controller 4, and outputs video and voice signals from the sub controller 8 to the display section 5.

The remote controller 4 includes a plurality of operation keys and transmits an operation signal over a wireless communication using an infrared ray or the like. The operation keys include number keys 18, operation keys 19 for the recording and reproducing apparatus such as a reproducing key, a record key, a fast-forward key, a fast-rewind key, and a video recording key, and combination keys 20. The combination keys 20 are keys for executing an operation mode of the recording and reproducing apparatus 2 or the television receiver 1. Specifically, the combination keys 20 include keys for turning up or down a volume in the television mode or moving a cursor leftward or rightward on a menu screen in the recording and reproducing mode, and keys for switching a channel in the television mode or moving the cursor upward or downward on the menu screen in the recording and reproducing mode.

The main controller 6 has an inquiry function of transmitting an inquiry to the sub controller 8 so as to confirm whether the operation signal is valid or invalid when the main controller 6 receives the operation signal by operating one of the combination keys 20. The sub controller 8 has a response function of responding to the inquiry from the main controller 6. Specifically, the sub controller 8 determines whether the operation signal is valid or invalid based on a present operation state, and transmits a response to the inquiry from the main controller 6 to the main controller 6.

When the sub controller 8 determines that the operation signal is valid, the sub controller 8 performs an operation according to this operation signal. When the sub controller 8 determines that the operation signal is invalid, the main controller 6 performs an operation according to this operation signal. In this way, the electronic apparatus control device according to the present invention is constituted by the main controller 6, the sub controller 8, and the remote controller 4.

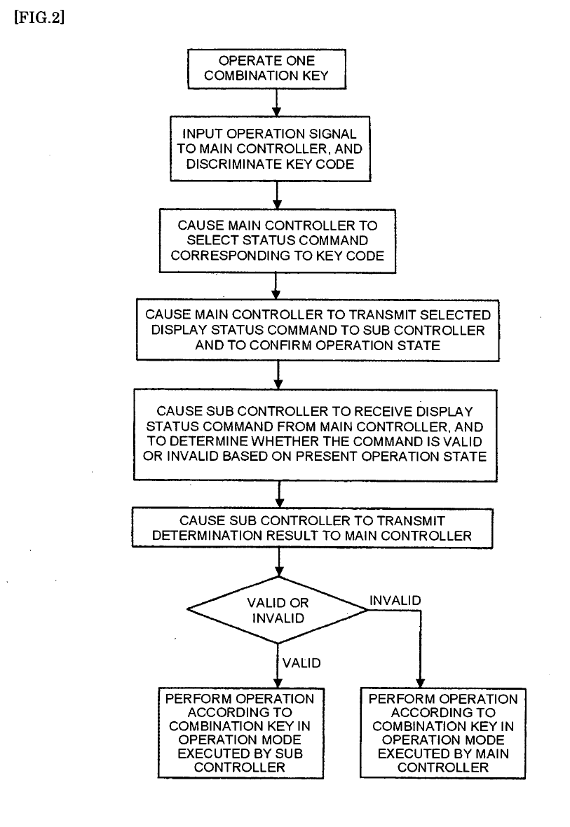

Operations performed by the electronic apparatus control device when one of the combination keys 20 on the remote controller 4 is operated will next be described based on FIG. 2. When a user operates a volume/cursor moving key that is one of the combination keys 20, the remote controller 4 transmits an operation signal according to this combination key 20. When the operation signal is input to the main controller 6 through the receiving section 14, the key code discrimination section 15 included in the main controller 6 discriminates the content of the key code included in the input operation signal. The control section 10 determines whether the operation signal is the operation signal by operating one of the combination keys 20 based on data transmitted from the key code discrimination section 15.

It is noted that status commands are allocated to the operation keys to correspond to the key codes included in the respective operation keys. For example, a display status command, a reproducing status command, and a power status command are allocated to a volume/cursor moving key that is one of the combination keys 20, a menu key, and a play key, respectively. A status command is a command for confirming the present operation state.

When determining that the operation signal is input by operating one of the combination keys 20 based on the key code included in the operation signal, the main controller 6 selects the display status command as the status command corresponding to the key code. The main controller 6 then transmits the display status command to the sub controller 8. When receiving this status command, the sub controller 8 determines whether the status command is valid or invalid based on the present operation state. Namely, the sub controller 8 determines whether an operation based on the operation signal can be operated.

The status command is valid when the sub controller 8 is executing the recording and reproducing mode. Therefore, the sub controller 8 transmits a response indicating that the status command is valid, to the main controller 6. Thereafter, the main controller 6 recognizes that the recording and reproducing mode is being executed, and performs an operation according to the operation signal. Namely, a recording and reproducing-related menu screen is displayed on the display section 5. The main controller 6 moves the cursor rightward or leftward on the menu screen, and the sub controller 8 performs an operation selected by moving the cursor, accordingly.

The status command is invalid when the sub controller 8 is not executing the recording and reproducing mode. Therefore, the sub controller 8 transmits a response indicating that the status command is invalid, to the main controller 6. The main controller 6 recognizes that the television mode is being executed, and performs an operation according to the operation signal. Namely, the main controller 6 turns up or down the volume.

As can be seen, when the user operates one of the combination keys 20 on the remote controller 4, the main controller 6 grasps the present operation mode by communicating with the sub controller 8 and performs an appropriate operation according to the operation signal. It is, therefore, possible to ensure executing a user's desired operation.

Needless to say, the present invention is not limited to the above-stated embodiment and many modifications and changes can be made to the embodiment within a scope of the present invention. The multifunctional device that is a combination of the electronic apparatuses is not limited to the multifunctional device according to the embodiment. The multifunctional device may be a combination of a digital recording and reproducing apparatus such as a DVD or a hard disk and an analog recording and reproducing apparatus such as a videotape, a combination of an analog recording and reproducing apparatus and a television receiver, a combination of a plurality of digital recording and reproducing apparatuses, or a combination of a plurality of analog recording and reproducing apparatuses. Further, the multifunctional device may be a combination of one of the above-stated audiovisual apparatuses and a personal computer, or a combination of three or more electronic apparatuses. If the multifunctional device is a combination of three or more electronic apparatuses, then controllers are provided in the respective electronic apparatuses, and one of the controllers is used as a main controller.

Furthermore, a form of the electronic apparatus control device is not limited to the form in which the electronic apparatus control device is provided integrally with the multifunctional device. The electronic apparatus control device may be provided in an independent form, and communicably connected to the respective electronic apparatuses. In addition, the remote controller serving as the operating device may be replaced by an operation panel provided integrally with the multifunctional device.

1. An electronic apparatus control device, comprising:
a plurality of controllers that execute different operation modes, respectively; and
an operating device that inputs an operation signal for executing one of said operation modes, wherein
the operating device includes a plurality of combination keys corresponding to operations performed in the plurality of operation modes, respectively,
the respective controllers are communicable with one another,
a main controller among the controllers includes:
receiving means for receiving the operation signal from said operating device; and
inquiry means for transmitting an inquiry to the controllers other than the main controller to confirm whether said operation signal is valid or invalid when the main controller receives the operation signal by operating one of said combination keys,
each of the other controllers includes response means for responding to the inquiry from said main controller,
an operation according to said operation signal is performed when said other controllers determine that the operation signal is valid, and
said main controller performs an operation according to said operation signal in one of the operation modes executed by the main controller when receiving a response indicating that the operation signal is invalid from one of the other controllers.

2. The electronic apparatus control device according to claim 1, wherein
the main controller selects a status command according to said operation signal and transmits the selected status command to the other controllers so as to confirm whether the operation signal by operating one of the combination keys is valid or invalid, and
the other controllers determine whether said status command is valid or invalid based on a present operation state.

3. The electronic apparatus control device according to claim 1, wherein
each of the controllers controls a recording and reproducing apparatus, and
the main controller controls an output apparatus connected to said recording and reproducing apparatus.

4. The electronic apparatus control device according to claim 2, wherein
each of the controllers controls a recording and reproducing apparatus, and
the main controller controls an output apparatus connected to said recording and reproducing apparatus.
